(19) United States
(12) Patent Application Publication
(10) Pub. No.: US 2003/0013438 A1
(43) Pub. Date: Jan. 16, 2003

(54) Pocket concierge system and method

(76) Inventor: George Eugene Darby, Mililani, HI (US)

Correspondence Address: GEORGE E. DARBY, P.O. BOX 893010, MILILANI, HI, 96789-3010, US

(21) Appl. No.: 10/201,916

(22) Filed: Jul. 22, 2002

Related U.S. Application Data
(63) Continuation-in-part of application No. 09/905,299, filed on Jul. 12, 2001.

(51) Int. Cl. H04M 3/00

(52) U.S. Cl. 455/419

(57) ABSTRACT

The Pocket Concierge Method and System comprises at least one call center, digital communications networks, at least one multimedia wireless terminal in which the primary user interface is not a keypad or keyboard, and navigational, informational, commercial, and communications services tailored to mobile users. The system and method of the invention are particularly suited to support supply chain and distribution channel management, and eCommerce, by persons who do not speak the language of a visited locale or of a vendor.

### RELATED APPLICATIONS

This application claims the benefit of the U.S. patent application Ser. No. 09/905,299, filed on Jul. 12, 2001, with a priority date of Jul. 12, 2000, in the U.S. Patent and Trademark Office for an invention entitled “Pocket Concierge and Multimedia, Wireless Call Center System and Method”.

### BACKGROUND OF THE INVENTION

1. Field of the Invention

Call centers are equipped and staffed for the provision to end-users of information services, especially technical support and reservation services. End-users may be: retail consumers, occupants of residential dwellings, hotel guests, tourists, employees of supply channel or distribution channel partners, consultants, internal staff, maintenance contract subscribers, travelers, etc.

Advanced call centers usually comprise: connectivity to public and private wide area networks, a call distribution system (either circuit switched or packet-switched, e.g., Voice over Internet Protocol, data call, instant message, etc.), a local area network, applications software, World Wide Web servers, database servers, application servers, workstations, wide area network connectivity, and personnel who operate workstations or “seats” in the call center and interact with callers to the call center.

A “helpdesk” is a call center that primarily provides technical information services. A “res center” is a call center that primarily provides reservation services. A “audiovisual call center” is a call center equipped to transmit to users of subscriber terminals multimedia messages, i.e., messages composed of sound, video, text, and/or graphical elements, and audiovisual messages, i.e., sound and video messages.

2. Description of Related Art

Call center technology began with automatic call distributors, and is now well established as a means to view customer account information while speaking with the account holders concerning account matters. To date, call centers, other than those for mobile phone carriers, have relied only incidentally on end-user wireless devices, for instance, to page a technician to answer a trouble call, or to update the memory contents of a remote device. See, e.g., U.S. Pat. No. 6,249,771, granted to Kurihara. Multi-media call centers are uncommon, and to date only call center personnel, but not end-users in wireless calls with such personnel, have had multimedia service. See, e.g., U.S. Pat. No. 6,212,178, granted to Beck, et al., in which media options provided by the call center to callers are email, text chat, voice chat, or fax. In short, multimedia services, especially video services, combined with call center services, directed to wireless device users is terra incognita.

With the advent of multimedia, mobile “smart phones,” XML and HTML browsers for small, handheld computers and smart phones, and high speed data channels serving such computers and phones, multimedia, wireless call center services have become technically and economically feasible. In particular, the high-speed data services under Unified Mobile Telephone System (“UMTS” or “G3”), wireless local area network (“WLAN”), and similar protocols will soon provide the technological platform for multimedia, wireless call center services, but unsolved problems remain concerning how to architect such systems, what services to provide, and how such services should be provided from operational, and end-user interface, standpoints.

There is considerable related art in the area of smartphones and in wireless connectivity for mobile computers, but little in the area of wireless information services that capitalize on the differential advantages of wireless connectivity over wireline connectivity. Email to a wireline computer is no different than email to a smartphone or a notebook PC on a wireless LAN. Email, ringer tone downloads, horoscopes, and the other services that made iMode a hit for NTT Docomo have not translated into making FOMA, NTT Docomo's G3 service, a hit. What makes wireless services to mobile devices compelling enough for subscribers to pay premium rates for higher wireless data rates? As shown by the sluggish adoption of FOMA in Japan compared with the meteoric adoption of iMode, technical capabilities alone, such as video calling, have not induced subscribers to move from G2 and G2.5 phones to G3 phones. A similar story has played out in the Republic of Korea: high data rate G2.5 and G3 phones with video calling have been deployed, but market penetration has been very low. The sophisticated mobile terminals and higher data rates deployed to date are apparently not the information services, systems architecture, mobile terminal design, and infrastructure for which subscribers will pay. This situation is an economic problem (given the staggering costs of G3 licenses), a service definition problem, and a systems infrastructure problem that no one has successfully answered.

In the related art, U.S. Pat. No. 5,809,115, granted to Inkinen, discloses an improved mobile terminal that shares processing loads between a wireless module and a portable computer. Inkinen's patent mentions that his invention can provide multimedia services by virtue of the digital connectivity of his improved terminal, but Inkinen's patent contains no reference to a call center, using a call center in conjunction with specific multimedia applications, or two-way video services. Rather, Inkinen is focused on the terminal architecture and balancing of processing loads between a wireless module and a portable computer.

U.S. Pat. No. 5,719,936, granted to Hillenmayer discloses a mobile phone combined with a keyboard, touch sensitive display, and optional video camera. Hillenmayer's patent mentions that his invention can provide “electronic data, for example, . . . telefax or. Email . . . ” by virtue of the digital connectivity of his improved terminal, but Hillenmayer's patent contains no reference to a call center, using a call center in conjunction with specific multimedia applications, or two-way video services. Rather, Hillenmayer is focused on the terminal device that combines a mobile phone, keyboard, and touch sensitive display. The functionality of Hillenmayer's touch-sensitive display is limited to switching fields and entry of handwriting, which functionality is consistent with an electronic business organizer. Hillenmayer's business organizer is not a general purpose computer. Similarly, U.S. Pat. No. 5,189,632, granted to Paajanen, discloses a mobile phone combined with personal computer, but contains no reference to a call center, using a call center in conjunction with specific multimedia applications, or two-way video services. U.S. Pat. No. 6,243,596, granted to Kikinis, discloses a battery pack combined with web browser that replaces the standard battery pack of a mobile phone but contains no reference to mobile general purpose computers, a call center, using a call center in conjunction with specific multimedia applications, or two-way video services.

U.S. Pat. No. 5,809,415, granted to Rossman discloses a two-way data network using mobile phones, pagers, and modem-equipped phones with a server computer that converts message formats as needed. Rossman's patent contains no reference to mobile general purpose computers, a call center, using a call center in conjunction with specific multimedia applications, or two-way video services.

U.S. Pat. No. 6,085,112, granted to Kleinschmidt et al. discloses a mobile phone with a display comprising either a clamshell screen or small heads-up projector. Kleinschmidt's patent contains no reference to mobile general purpose computers. The Kleinschmidt patent refers to information services, including services serving images, but contains no reference to a call center, using a call center in conjunction with specific multimedia applications, including a video camera in the mobile phone, or two-way video services.

U.S. Pat. No. 6,192,255, granted to Lewis et al. discloses a supplemental processor module that can be used with both mobile phones and wireline phones. The focus of the Lewis patent is on providing additional processing power packaged in a removable module. The additional processing power can be general, or specific to a particular information service. The Lewis patent refers to information services, including services serving images, but contains no reference to a call center, using a call center in conjunction with specific multimedia applications, including a video camera in the mobile phone, or two-way video services.

None of the related art includes the use of a call center (as defined above), using a call center in conjunction with specific multimedia applications, including a video camera in the mobile phone (except for Hillenmayer's single mention), or two-way video services. The related art approaches mobile terminal design from the standpoint of wireline multimedia services being interchangeable with mobile information services (with accommodation of mobile terminal displays having fewer pixels), rather than mobile subscribers' information needs driving information and systems architecture, and consequently terminal functionality and terminal design.

The primary end-user interface in each of the related art references above is a keypad or keyboard. Eliminating a structural element (i.e., keyboard or keypad) essential to the functioning of a device means that a later device without that structural element does not infringe the earlier device.

One approach not identified by the related art to defining the information services, systems architecture, mobile terminals, and infrastructure is to take the perspective of a visitor in a foreign country using a mobile device for the first time in an unfamiliar locale populated by speakers of an unfamiliar language, but with a requirement to accomplish tasks as expeditiously as the visitor would in the visitor's hometown. Such a person has the highest information needs of any person, and will pay a premium for services that enable the accomplishment of those tasks. Such a person would not use the device primarily to make traditional telephone calls, therefore the primary user interface would not be a keypad or keyboard. Revisualizing the design context for G3 services in this manner leads to restatement of the design problem, and results in different design solutions. Such solutions emphasize using a touch-sensitive graphic user interface (“GUI”) display as the primary user interface, at least one multilingual call center in conjunction with specific multimedia applications, providing multilingual mobile terminals, using short-range and longer range wireless networks, including a video camera in the mobile terminal, using two-way video services, and providing video-based, graphical, and/or voice-based navigational, negotiation, and purchasing services. The Pocket Concierge System and Method is based on such an approach and encompasses such solutions.

### SUMMARY OF THE INVENTION

The Pocket Concierge System and Method, called herein the “Pocket Concierge service”, comprises three subsystems: an end-user subsystem, a call center subsystem, one or more digital communications networks. A Pocket Concierge service operator provides various information and facilitation services to end-users. The Pocket Concierge service is normally operated using points of sale and points of offer subsystems.

The end-user subsystem is a wireless digital telecommunications device (“Wireless Module”) closely interfaced with a mobile computing device (“Pocket Computer”), such as a pocket PC or other small computers. The end-user subsystem (the combination of the Wireless Module and the Pocket Computer) is called herein the “Pocket Part”. The Pocket Computer contains at least an XML/HTML browser, input/output interface to the Wireless Module, a display capability, a data entry capability, audiovisual (“multimedia”) capability, and the other normal parts of a computer (CPU, ROM, RAM, systems software, applications software), and optionally, removable storage, and additional interfaces.

The display component of the Pocket Computer normally includes a color, touch sensitive, LCD panel on the face of the Pocket Computer, but the display could be a goggle, tactile or skin pad, video projector, or other human interface output device interfaced with the Pocket Computer.

The data entry component of the Pocket Computer normally includes the touch sensitive LCD panel (“touch screen”) with a “soft keyboard”, handwriting recognition, and, optionally, voice recognition capability. The data entry component could be a touch sensitive device other than an LCD screen, or a motion sensitive device such as a video camera.

The audiovisual component of the Pocket Computer, in addition to the display component, normally includes a microphone, loudspeaker, earphone, and, optionally, a video camera, text to speech processor, speech to text processor, or other functionality described below. The microphone and earphone are normally combined in an earset (an ear mounted headphone and boom microphone). A handset can be used in lieu of an earset.

The Wireless Module is a base, insert, or jacket that mates with the Pocket Computer, or a smaller electronics module in PCMIA, Compact Flash, sleeve, USB interface, Firewire interface, and similar “removable” form factors, or with a wireless interface to the Pocket Computer. The Wireless Module can also be an internal module within a Pocket Computer, creating a type of “smart phone” or “very smart phone”. The Wireless Module provides voice, data, and audiovisual communications between the Pocket Computer and the call center subsystem using wireless communications technologies. The Wireless Module can operate on one or more RF bands and airlink standards. Where local wireless service is not available, orbital satellite services can be used with a satellite capable Wireless Module; satellite services data rates are slower than terrestrial wireless data rates, but are adequate for voice, Internet access, and relatively static graphics, such as maps.

The Compaq H3600 iPAQ series of Pocket Computers, available from Compaq Computer Corporation, 20555 SH 249, Houston, Tex. (www.compaq.com), was the first commercially available product that provides the minimum complement of features required for the Pocket Part. The Compaq H3600 Pocket PCs have: an XML/HTML browser; a color, 320×240 pixel, touch sensitive screen; input/output interface to a Wireless Module; data entry using soft keyboard (i.e., the end-user selects a given letter by touching the appropriate letter on a miniature keyboard displayed on the LCD screen), microphone, loudspeaker, and headphone jack. Wireless Modules for the H3600 uses various airlink standards, e.g., GSM, CDMA, and soon UMTS. Although Wireless Modules that use telephony airlink standards are described, other airlink standards could be used, e.g., cellular packet data, private radio, satellite. The Pocket Part normally includes a proximate area network interface (e.g., Bluetooth, IEEE 802.11, other wireless local area network, infrared) for local wireless communications. The Pocket Part can include a terrestrial network interface (dial-up modem, serial port, USB port, etc.) as failover or backup support if wireless access is not available. Several other Pocket Computers are available, such as the Toshiba e740, which includes a WLAN or Bluetooth transceiver. All telecom services used by the Pocket Part are digital, which requires that the Pocket Part have an audio codec and a video playback codec. A Pocket Part equipped with a video camera also has a video compression codec to compress the video signal originating at the Pocket Part. The audio and video codecs can be selectable rate codecs to permit use of higher data rates when available or when affordable.

The Pocket Part software applications support one or more of the following information services: voice calling, data calling, paging, audioconferencing, videoconferencing, sensor monitoring (e.g., biological, environmental, video, personal security), location (based on geostationary positioning satellite (“GPS”), LORAN, VORTAC, etc.), remote sensing, remote diagnostics, reservations, entertainment, shopping/procurement, office, program playback, and vertical industry (sales force automation, engineering, construction, medical, manufacturing, extractive, etc.) services.

The call center subsystem, hereinafter called the “Call Center,” uses commercially available call center components, e.g., connectivity to one or more public and private wide area networks (including satellite, fiberoptic, and the wireless network used by an end-user subsystem), a circuit-switched call distribution system, a packet-switched (e.g., Voice over Internet Protocol, data call, instant message, etc.) call distribution system, a local area network, applications software, World Wide Web servers, database servers, application servers, and workstations. The Call Center supporting the wireless connection to a Pocket Part is called the “serving Call Center”.

The digital communications network subsystem uses commercially available wireline and wireless digital networks, hereinafter called the “Networks.” A terrestrial or satellite wireless network is used to reach the Pocket Parts. Wireline and/or wireless networks interconnect the Call Center with network, human, or institutional resources required to respond to end-user requests. The advent of national wireless providers with flat rate calling plans and high-speed data service using existing airlink standards, such as CDMA, enables Pocket Concierge service to be national in scope (or international, where international roaming agreements, the same airlink standard, and multi-band Wireless Modules are available). With the deployment of UMTS, international Pocket Concierge service will become easier to implement. UMTS terrestrial service data rates range from 384 Kbps to over 2 Mbps, which are more than adequate to support wireless multimedia, including videoconferencing and digital television. The Pocket Concierge service is normally operated using points of sale and points of offer subsystems. If points of sale and points of offer are used, the Wireless Module and the points of sale and points of offer exchange wireless messages using a proximate area network technology.

### BRIEF DESCRIPTION OF THE DRAWINGS

FIG. 1 illustrates the basic components of the Pocket Concierge service.

### DETAILED DESCRIPTION OF THE PREFERRED EMBODIMENTS

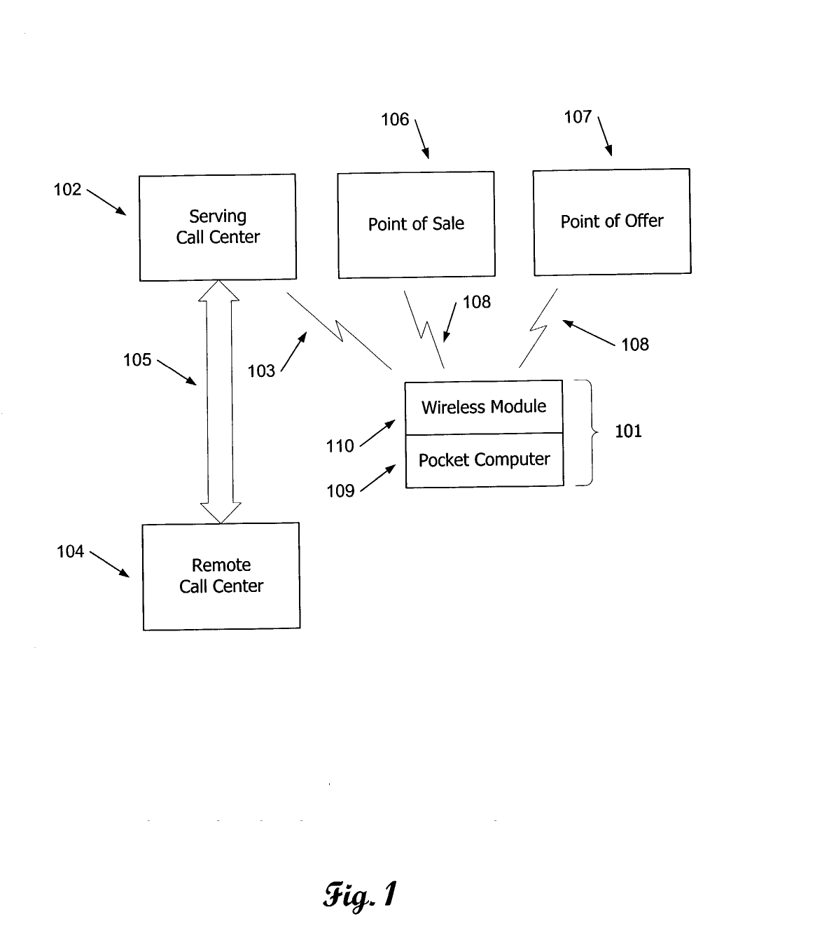

As shown in FIG. 1, the Pocket Concierge System and Method invention comprises is a Pocket Part (101), a serving Call Center (102), and a wireless link (103). One or more remote Call Centers (104) connected to the serving Call Center by a Network (105), and one or more optional Points of Sale (106) and Points of Offer (107) connected to the Pocket Part (101) by proximate area network links (108), are used in the preferred embodiment. A Pocket Part comprises a Pocket Computer (109) and a Wireless Module (110). The Pocket Computer (109) contains at least an XML/HTML browser, input/output interface to the Wireless Module, a display capability, a data entry capability, audiovisual (“multimedia”) capability, and the other normal parts of a computer (CPU, ROM, RAM, systems software, applications software), and optionally, removable storage, and additional interfaces. The Wireless Module (110) contains at least an input/output interface to the Pocket Computer, a wireless transceiver for the wireless link (103), and an optional proximate area network transceiver for the proximate area network links (108). The serving Call Center has connectivity to wireless links (103) and to the Network (105). The Pocket Concierge service is normally operated using points of sale and points of offer subsystems. If points of sale and points of offer are used, the Wireless Module and the points of sale and points of offer exchange wireless messages using a proximate area network technology and contain proximate area network transceivers.

The multimedia component of the Pocket Concierge service depends upon high data rate wireless services. UMTS holds particular promise for full-time connectivity of the Pocket Part, with instant availability of high data rates. UMTS data services can be priced by the packet instead of by the minute. For instance, in telemedicine and telesecurity applications, the call center subsystem can maintain full-time contact with a Pocket Part. Transmission costs are incurred only when defined events occur that require that a message be sent from the Pocket Part, such as departure from or entry into a secure area in a telesecurity application, or low blood pressure in a telemedicine application.

In addition to the novelty in the combination of the elements described above in the Summary of the Invention section, additional inventive steps in the Pocket Concierge are as follows:

End-user security features. Pocket Concierge service improves the safety or confidence of persons exposed to risk or lack of information. For an end-user exposed to medical risk, the Pocket Part can monitor vital signs, air quality, water quality, etc., and alert a Call Center of any deterioration in medical or environmental condition. For an end-user exposed to physical risk, the Pocket Part can monitor the audio and video environment of the end-user, vital signs, sensors (dosimeters, impact sensors, etc.), and dispatch assistance if a threat is detected by monitoring or if assistance is requested by the end-user. If full-time transmission of audio and video is not warranted, a request for assistance or a need to confirm the status of the end-user can be inferred if the end-user fails to respond when polled by a Call Center, or if sensor readings (impact, ambient oxygen levels, etc.) exceed or fall below threshold levels. If an end-user does request assistance, Call Center personnel or a software agent can alert or conference in the appropriate dispatch service (fire, police, ambulance, Coast Guard, search and rescue, etc.), and provide language translation as needed. In another area of physical security, Pocket Parts equipped with optional tactile pad outputs (for navigation data output) could be used by sight-impaired persons to navigate, especially in unfamiliar areas. A Pocket Part can be interfaced with building security systems, e.g., a residential security system, to avoid loss of contact by a building security system with a security services call center if the wireline connection to the building is interrupted, e.g., cut by a burglar.

The Pocket Part can provide interactive navigation for pedestrians and drivers. In an automotive embodiment, the Pocket Part can be used in conjunction with an optional video output and external video display (e.g., LCD panel) visible to the driver; the external video display could be a “heads up” display projected on a windshield. In an embodiment for pedestrians, the external video display could be a semi-reflective screen attached to the Pocket Part or to a miniature video projector interfaced with the Pocket Part. A button or menu selection on Pocket Part can be dedicated to presenting an instant display of the location of the end-user and/or of the destination or other points of interest. Location detection can be based on wireless triangulation (wireless carrier, proximate area network, or GPS). Location detection can also be provided by points of offer and points of sale, as defined below, whenever an end-user passes within range of a point of sale or point of sale transceiver.

In additional to “electronic wallets” and other payment agents well known in the art, the Pocket Part can provide additional security for financial transactions and for other transactions involving disclosures of personal information. The Pocket Part can contain a card swipe reader, biometric reader, stored value means, smart card, smart media, and/or voice reader module built into or interfaced with the Pocket Part. The card swipe reader reads a credit card, smart card, or other card with stored information that is not embedded in the Pocket Part. A stored value means, smart card, or smart media integral or interfaced with the Pocket Part can also be used to support settlement of payments. The biometric reader uses the Pocket Part touch screen or video camera and a biometric analysis software application to read hand geometry, retinal map, one or more fingerprints, or other anatomical feature to authenticate the end-user. The voice reader uses a microphone associated with the Pocket Part (either integral with the Pocket Part or in the earset) and a voice analysis software application to authenticate the identity of the end-user. The analysis software application can be resident on the Pocket Part, a Call Center, or on a server interfaced with a Call Center. User authentication can use a combination of the preceding methods.

Pocket Part asset management. The Pocket Part is small, highly portable, and moderately expensive (approximately $600 in basic configuration, assuming a $150 Wireless Module and a $450 Pocket Computer). Loss of Pocket Parts through theft or misplacement is a very real risk to a Pocket Concierge service operator. To deter theft and to enhance recovery of Pocket Parts, the Pocket Computer and Wireless Module, if manufactured as separate units, are tightly bonded with fasteners or adhesives so that separation without the proper tools or solvents would result in destruction of the Pocket Part. A Pocket Part inventory tracking program resident on a “Pocket Part asset management server” interfaced with a Call Center can periodically poll the location of each Pocket Part managed by that Call Center to ensure compliance with any geographic limits of permitted use of the Pocket Part. If geographic limits are exceeded, the Pocket Part can be disabled except for emergency services, or the end-user can be surcharged for a wider geographic operating area. The determination of the location of a Pocket Part is by RF triangulation, RF proximity detection, transaction history (as described below), and other methods known in the art. Within each Pocket Part is an optional emergency battery that initiates a location report even if the main battery of the Pocket Part is fully depleted, similar to the use of an Emergency Locator Transmitter in aircraft. In the event the emergency battery dies, and thereafter the Pocket Part is recharged and connected to a network, within each Pocket Part is a firmware application that reports the location of the Pocket Part (without informing the end-user of the transmission of such tracking messages), even outside the original Pocket Part service area; if wireless service is available, the report is made by wireless connectivity to any terrestrial or satellite wireless service available for such purposes; the report is normally made by Internet email, datagram, or a dialup call to the Pocket Part asset management server. As a further precaution, the Pocket Part can optionally remain operative only so long as it receives an encrypted “keep alive” command from the serving Call Center. In this optional embodiment, if the Pocket Part does not receive the keep alive signal for a preset period of time, the Pocket Part deactivates and displays only a “Contact Call Center”, or similar message, and requires either entry of a password or receipt of an encrypted “revive” command from a Call Center to be reactivated. An RF resonant tag can be included in the Pocket Part that emits an RF reply when in the vicinity of the proper RF field, much like tag detection systems in retail stores and libraries. RF tag detection can be used at places of mass transit, such as airports and train stations. Detection of a missing Pocket Part by one of the preceding means generates a report to the Pocket Part asset management server and initiates a recovery operation.

Core services: Call Center usage and Network access. Call Center services and access to private and public networks, particularly the Internet, are normally the core services in most embodiments of the Pocket Concierge service. Call Center services reflect the purpose of the enduser's activities: business, leisure, residential, or a mixture thereof. Local and remote information resources are made available to a Call Center over the Networks to support the Pocket Concierge services provided to end-users.

The first core service is training a new user of a Pocket Part in the use of the Pocket Concierge service. Returning to the design philosophy of the Pocket Concierge service, a visitor in a foreign country using a mobile device for the first time in an unfamiliar locale populated by speakers of an unfamiliar language must first learn how to use the device. Training a new end-user of a Pocket Part begins with the user's selecting a preferred language and optionally entering in the Pocket Part other personal information and preferences that comprise a user profile. Data entry is by touch-sensitive screen or by voice recognition. The end-user can then review text and/or multimedia training materials about use of the Pocket Part. Such training materials can automatically be downloaded from a Call Center or Network server as needed. If the end-user needs further assistance, the end-user can speak with a trainer at a Call Center.

One business embodiment of the Pocket Concierge service is tailored to sales of financial services, such as insurance, investments, and banking. In this financial services embodiment, for example, graphic and tabular illustrations of insurance, investment performance, and banking services are delivered to the Pocket Part based on real-time inquiries from a salesperson meeting with prospects or clients. A subject matter expert, normally at a Call Center, can be videoconferenced or audioconferenced into the meeting as needed using the Pocket Part. A videoconferee or audioconferee can be at the serving Call Center, or at a remote Call Center and connected over a Network to the serving Call Center and the end-user. If the Pocket Part is interfaced with a videoprojector, the subject matter expert, graphics, and other incoming audiovisual content can be projected on a suitable surface at the location where the Pocket Part is being used.

Use of the Pocket Concierge service is particularly effective in international business applications, since it enables a central repository of product information and helpdesk experts to be maintained by a company, in the languages of the company's markets, and distributed just-in-time as requested by end-users with Pocket Parts in various countries. In such applications, fiberoptic segments, and optionally satellite services segments, of the Network are used to connect a Call Center in the company's home country with Pocket Concierge service operators in foreign markets. If fiberoptic Network service is used, given the low latency of uncongested fiberoptic transmission, the Call Center and Network server response time is not perceptibly longer in a foreign country than in the company's home country. If the Internet is used as a segment of the Network, congestion is more likely and can lengthen response times. With Call Center or Networked personnel (subject matter experts and other personnel accessed through the Network) skilled in both the relevant foreign language and in the company's products and services, such Call Center personnel can take the lead in presentations if a representative of the company in the foreign country is not highly trained and/or is not fluent in the foreign language. By participating in such presentations, and in tele-training programs delivered through the Pocket Concierge service, personnel can be trained without shuttling training personnel around a nation or around the world.

Pocket Concierge service can be used in communities, such as tele-education programs for schools and universities, to provide guest lecturers from a Call Center or other Networked location, or to provide a full course or curriculum. Where an enterprise owns full-period rights to the use of the Networks and Pocket Parts, or subsidizes their use, tele-education, disaster relief, and other humanitarian activities can be provided as a community service, to enhance a company's image, and to assist in recruitment.

The Pocket Concierge service can provide a “follow me service”, so that voice, fax, video, and data calls are received at an end-user's various network addresses (including telephone numbers), the payload of such calls converted into packets using methods known in the art, and forwarded to the end-user's Pocket Part. The Pocket Part has all the functionality of a mobile phone, including registration on a home or a roaming wireless network when powered up, which enables messages to reach the end-user when the end-user is roaming.

At least one embodiment of the Pocket Concierge is tailored to the travel industry, especially for use by visitors to a foreign country who do not speak the language of the country being visited. As an example, many Japanese visitors to the U.S. would like to experience more than being a member of a tour group, but do not have the fluency or literacy in English to travel comfortably solo or in small groups. In one travel industry embodiment of the Pocket Concierge service, a Japanese-speaking visitor would use a Pocket Part with a Japanese language user interface. When the end-user visitor had a question about the availability of services or goods (e.g., accommodations, transportation, entertainment, dining, sightseeing, retail goods, vendors, and other items of information), the end-user would place a voice call to the serving Call Center just as any Pocket Concierge end-user would, as follows: the end-user mounts an earset plugged into the Pocket Part and presses the appropriate button, soft button (a labeled area on the touch sensitive screen or a dynamically labeled area set apart (usually by a mask) from the main viewable screen), or hyperlinked text on the touch sensitive LCD screen of the Pocket Part, such button or hyperlinked text is programmed to call the serving Call Center (in this example, a Japanese speaking “seat” (workstation and operator) at the serving Call Center or at a remote Call Center, depending upon the language profile entered for the calling Pocket Part or selected by the end-user). The Call Center agent answers the call and provides the requested information, such as navigation instructions, shopping and vendor information, etc. As required, the Call Center agent identifies and accesses a network resource (database or application server, etc.) or conferences in a human, or software agent, subject matter expert. The call between the end-user and the Call Center might be audio only, or it might include video of the Call Center agent (and others) involved in answering the call; with a camera-equipped Pocket Part, the call can include video from the end-user, such as video of an artwork, street intersection, building, goods, or person. The agent answering the call can be a software agent instead of a human. If video from the Call Center is used, the agent could be an animation, either life-like or cartoon-like, selectable by the end-user. To reduce transmission capacity, the graphic elements, lip motion rules, and body motion rules of the animation could be embedded in the firmware of the Pocket Part. Commands from the relevant Call Center would control the execution of the graphic elements and rules for display on the Pocket Part, which saves wireless bandwidth.

Navigation assistance is a one of the most important Pocket Concierge services. In a typical navigation session, in response to a call for navigation assistance from an end-user, the Call Center provides voice and/or screen-based directions to the end-user. The end-user might be walking or in a vehicle, boat, or other conveyance. Animations could be superimposed on a map on the Pocket Part display to guide the end-user in navigating to a destination. For end-users with visible light camera-equipped Pocket Parts, a more sophisticated method of navigation assistance is to match video from the end-user's Pocket Part camera showing the end-user's locale with a wireframe model of that locale previously stored in and now sourced from a Call Center or Network server and superimposed (overlaid) on video of the locale seen by the end-user on the screen of the Pocket Part. A wireframe model contains only essential details of streets, structures, and other environmental features; additional text or navigational detail is typically superimposed on the locale video and referenced to the wireframe model. The wireframe model is dynamically constructed at the Call Center or Network server by a wireframe model server to provide the perspective within the wireframe model of the locale that is correct for the perspective in the source video from the Pocket Part. The additional detail explains in text the contents of the structures or other environmental features (e.g., business name, products, services, risks, history, account data, staff, etc.) and in icons and text navigation through the locale from the end-user's perspective (more exactly, from the video camera's perspective). The additional detail is referenced to features in the wireframe model by positioning the additional detail within the frame and optionally by callout arrows. The Call Center or Network server generates a composite video of the locale video, wireframe model, and additional detail. The composite video is then transmitted to, and displayed on, the Pocket Part that requested navigational assistance. For instance, a tourist standing across the street from a building of interest can point the Pocket Part video camera at the building, and see on the Pocket Part display the internal layout of the building (i.e., the wireframe overlay), information about the various commercial premises and tenants in the building (i.e., the additional detail), and navigational directions to a given tenant's premises. Moreover, the displayed information can have drill-down informational navigation, i.e., the displayed information can be navigated using database drill-down techniques known in the art to show more detailed information and/or different views of the information. Returning to the example of the tourist viewing the building, the tourist could select a restaurant, then drill down to menus of the restaurant translated into the tourist's selected language. The tourist could then use the Pocket Part to navigate to the selected restaurant, enter his or her food order using the Pocket Part, and show a waiter the selected food order in a language understood by the waiter. Alternatively, the food order could be entered over a proximate area network connection directly into the restaurant's local area network.

In place of, in addition to, a video camera sensitive to visible light, an infrared camera or multispectral camera can be integral, or interfaced, with the Pocket Part. The “night vision” infrared image of a Pocket Part user's locale (or other subject matter) can be used for navigation, telemedicine, telesecurity, and other services as described above for services using visible light video. An infrared camera particularly improves navigation services at night: although the locale may be poorly illuminated, a wireframe model and additional detail can be overlaid on an infrared video image in the same way as a visible light video image. A multispectral camera sends separate video signals for each of multiple frequency bands in the infrared, visible, and ultraviolet spectral range. Some multispectral systems generate signals for almost 300 separate bands. The multispectral image of the locale, patient, (or other subject matter) can be used for navigation, telemedicine, telesecurity, and other services as described above for services using visible light video. Multipsectral imagery is particularly important in telemedicine and environmental monitoring applications.

“Wireframe overlay” navigation, as described above, is typically used in conjunction with voice communications with a Call Center, at least during an end-user's initial visit to a given locale. Having interactive voice guidance from a Call Center can accelerate finding the right building to capture using the Pocket Part video camera. For instance, in a first visit to a locale, the visitor may emerge from a subway station exit and be disoriented, or may even be at the wrong subway station. Since not everyone can read and follow map instructions, live feedback from Call Center personnel directing the end-user in pointing the camera or in navigating a map displayed on the Pocket Part screen overcomes such disorientation. In some situations (e.g., while driving or in high risk pedestrian areas), the end-user may not wish to view the Pocket Part display, and would rely on voice instructions from the Call Center to navigate to a location. In such situations, the Call Center personnel view geolocational information showing the location of the end-user's Pocket Part (e.g., from triangulation using PAN nodes) on a screen at the Call Center, and direct the end-user's progress.

Instead of a voice call, the end-user could prepare a written inquiry (email) and send the email to a Call Center using a data call. Each type of service . . . human operator interaction, software agent interaction, or email interaction . . . could have a different service charge or be accounted for separately by tier of service purchased. A certain amount of data calling (by number, packet, or transmission time) and voice calling is normally included in the basic Pocket Concierge service tier, but amounts in excess of a threshold incur surcharges. Normally included in higher tiers of Pocket Concierge service are specified amounts of Internet access (for Web surfing, email, etc.), games, entertainment, and other information services; amounts in excess of a tier threshold incur surcharges. The Pocket Part can be used as an office, meeting room, airline cabin passenger, airline lounge, or hotel guest room information appliance, especially in conjunction with a an optional video output and external video display (e.g., LCD panel).

The reply from a Call Center to an end-user inquiry involving the location of goods or services normally provides (i) maps to the end-user that display on the Pocket Part, together with the enduser's current location, and (ii) exact directions on how the end-user should proceed to reach a given destination. The display maps and end-user location are updated as the end-user walks, rides, drives, etc. The maps, directions, and other display contents are in the native language of the end-user (Japanese in the tourist example above), and can also be bi-lingual (in both the end-user's language and the local language in the visited country), to facilitate asking bystanders for assistance. Display of two or more languages is selectable by the end-user. The functional details of the use of a Pocket Part described in the preceding travel industry embodiment are equally applicable to other end-user segments (e.g., sales force automation, engineering, construction, medical, manufacturing, legal, etc.).

The Pocket Concierge service operator may elect to selectively block voice over Internet calls to require end-users to pay separately for interstate and international calling. Local calling is normally an included service, with amounts varying by tier. Network access, including Internet access, can be measured by time or packets. An optional reward system linked to the purchase of goods or services, performance in games, or contest results, using the Pocket Concierge service can be employed to generates usage credits to offset surcharges for Internet access, long distance calling, or other services in excess of the amounts included in a pre-purchased tier.

An optional digital camera in the Pocket Part can be used for videoconferencing, and can also store digital photos either in memory in the Pocket Computer, or by transmission from Pocket Part to a storage server. Such transmission can be by airlink, proximate area network, or by docking the Pocket Part in a wired network.

A text file is usually smaller than the speech file that contains a spoken version of the text in such text file, and requires less network transmission time and storage space than such speech file. It is therefore desirable to provide audio programming based on text in text form to a Pocket Part. An alternate embodiment of the Pocket Part can be equipped with a text-to-speech and/or speech-to-text software process or hardware processor. If a hardware processor is used, it can be integral with the Pocket Part, removable (e.g., Compact Flash unit), or have another type of interface (e.g., wireless, USB, Firewire). A Pocket Concierge text-to-speech service is the provision of a text file to a Pocket Part and conversion of a text file previously stored on the Pocket Part, or upon end-user request streamed to the Pocket Part, to speech for audition by the end-user (or for other use, e.g., amplification for an audition by an audience) in the same language as the text, and optionally in another language selected by the end-user. A Pocket Concierge speech-to-text service is the conversion of the end-user's speech (or speech from another source, e.g., a recording stored on, or live feed to, the Pocket Part) to text in the same language as the source, and optionally in another language selected by the end-user. Text converted from speech is useful in preparing email, meeting minutes, and other documents. Conversion to or from a language different from the source text in a text-to-speech conversion, or from the source speech in a speech-to-text conversion, requires that the software process or hardware processor be equipped (or have network access to) natural language machine translation. The “narrator voice” used for text-to-speech conversion can be selected by the end-user, e.g., male, female, accent, dialect, etc. Servers at the Call Center or on the Network download or stream text files in response to end-user requests. Text files for the text-to-speech services can be downloaded during periods the Pocket Part is placed in a docking station connected to a Network. For example, a news service can download news of general or user-specified topics at user-specified intervals, only when the Pocket Part is docked in a docking station, or on a different schedule. The end-user can elect to view the text files for reading, or listen to the content of the text files after conversion to speech. Listening to audio programming, such as news, is more convenient than reading text files in many situations, such as when driving an auto, riding in public transport, or in poorly illuminated areas.

The most expensive, commonly available high speed data service for mass markets is G3 wireless data services (presently available in Japan and Korea, but to be introduced globally). The lack of “service level management” for smart phones and similar wireless devices is one factor slowing the adoption of G3 devices and services for G3 devices. Stated differently, a major concern of managers responsible for paying for expensive network services is whether the services delivered meet the minimum criteria for which the manager contracted. Such manager can be a Pocket Concierge operator who contracts for wireless services between a Call Center and Pocket Parts, or an enterprise buyer of Pocket Concierge services (e.g., a buyer of Pocket Concierge sales force automation services for an international sales force). The preferred way to address this concern is by “service level management” tools that monitor and report on whether delivered services levels, particularly datarate, network availability, and software application availability, met, exceeded, or failed contract requirements. In an alternative embodiment of the Pocket Part, the Pocket Part contains a service level management (“SLM”) agent that monitors and reports on delivered service levels. The SLM agent, defined below, can be integral with the Pocket Part, removable (e.g., Compact Flash unit), or have another type of interface (e.g., wireless, USB, Firewire). The SLM agent in a Pocket Part can monitor and report on one or more networks and applications serving that Pocket Part, e.g., G3 wireless connections, PAN connections, navigation services, GPS services, etc. SLM technology, SLM agents, and SLM servers, defined below, are well known in the art of network management. In the Pocket Concierge service, an SLM server at a Call Center or elsewhere on the Network polls SLM agents to collect SLM data and reports, or otherwise receives such SLM data and reports from Pocket Parts. The SLM server then prepares and delivers SLM alerts and SLM reports to a subscriber to such SLM service, e.g., a Pocket Concierge operator or an enterprise buyer of Pocket Concierge services. An “SLM alert” is a message that promptly reports a service provider's failure to comply with a service level for which such SLM subscriber contracted. An “SLM report” summarizes SLM events, typically including alerts, network availability, and application availability, over a given time period. SLM agents can also be installed in, or interfaced with, PAN nodes (transceivers that provide proximate area network services), points of offer, and points of sale; these SLM agents monitor and report on service levels to PAN nodes, points of offer, and points of sale, respectively; optionally, SLM agents at PAN Nodes can monitor and report of service levels to Pocket Parts. A given SLM server can only handle a finite number of SLM agents. In a “multi-tiered SLM” architecture, lower-tier SLM servers serving a plurality of SLM agents report to a higher-tier SLM server; that higher-tier SLM server in turn can report directly to a master SLM server, or indirectly through intermediate-tier SLM servers to a master SLM server.

Direct sales, advertising fees, and commissions. Pocket Concierge service operator revenue comes not only from basic service fees to end-users (or to intermediaries, who in turn provide the Pocket Parts to end-users), but from direct sales of goods and services, from advertising fees, and from commissions from online, and off-line, coupon-based, sales to end-users by participating merchants. Coupons can be bundled with merchants' advertisements, or can be distributed without a related advertisement. Coupons can be paper based or electronic. Electronic coupons are normally redeemed by transmission over the proximate area network serving the Pocket Part to a a point of sale. Normally, the PAN node closest to a Pocket Part provides connectivity from the PAN node to the Pocket Part. The point of sale can have a wireline or wireless connection to the Network to complete the connection between the PAN node serving the Pocket Part and the point of sale; if the point of sale has wireless connectivity to the Network, it may be, but is not necessarily, served by the same PAN node that serves the Pocket Part that is redeeming the coupon. Based on the subject matter of the inquiry from an end-user, advertisements related to inquiry subject matter could be displayed on the Pocket Part. The advertisements could be coupled with coupons, and the coupons could be time sensitive electronic coupons, that is, the coupons must be redeemed with a limited period of time. Moreover, the mere proximity of a Pocket Part, based on the detection of a proximate area network “announcement” transmission from the Pocket Part by nearby PAN node, could trigger the transmission of advertisements and/or coupons to the Pocket Part. The Pocket Part announcement message normally discloses the preferences of the end-user, but usually not his or her identity or other personal information. User information (i.e., the Pocket Part profile) is normally entered into the memory of a Pocket Part when the Pocket Part is initialized for a new end-user, and can be modified thereafter by a Call Center during a call or, optionally, by the end-user alone. The end-user preferences normally include shopping or procurement information such as the items, types of items, discount levels, quantities, etc., the end-user seeks. Software in the Pocket Computer can negotiate with software agents maintained by merchants and present an offer to the end-user on the display of the Pocket Part in the end-user's language as the end-user passes a merchant's point of offer. (A point of offer is where product or service information is available but a sale cannot be transacted; for instance, there may be no inventory of goods at a point of offer and a purchaser may wish to inspect the goods before purchase. A point of sale is where goods are sold and can be delivered. A point of offer can connect an end-user to a point of sale. Like a point of sale, a point of offer can have a wireline or wireless connection to the Network to complete the connection between the PAN node serving the Pocket Part and the point of offer; if the point of offer has wireless connectivity to the Network, it may be, but is not necessarily, served by the same PAN node that serves the Pocket Part that is receiving the offer.) The proximate area network “arrival announcement” and point of offer reply also has application in trade shows and commerce courts. If the location of the point of sale is not obvious or provided by a message from the point of offer, a Call Center can provide directions from the point of offer to the point of sale; providing a map and navigation service normally incurs a fee paid by the merchant to the Pocket Concierge service operator, since the service operator has control over the display of maps and navigation on the Pocket Part. Alternatively, merchants could provide text directions from point of offer to point of sale as part of the exchange of messages over the proximate area network. A credit card swipe reader, stored value means, smart card, smart media, biometric reader, or voice reader built into Pocket Part, etc., built into or interfaced with the Pocket Computer component of the Pocket Part facilitate end-user authentication, sales transactions, and data entry.

Under the terms of use of the Pocket Part, the Pocket Concierge service operator normally reserves the right to display advertising on the Pocket Part. The end-user can be offered a reduced Pocket Part rental rate in exchange for viewing, or viewing and responding to, a threshold number of advertisements. Possible responses include a purchase, participation in a market research survey, referral of a prospect, or other acts by the end-user. Alternatively, the terms of service can be that no advertisements, coupons, or promotional messages are permitted unless certain conditions are met, as determined by the Pocket Concierge service agreement with the end-user. Setup of the Pocket Part to block or selectively permit advertisements and coupons normally increases the price to the end-user of each tier of service, since advertising revenue otherwise paid to the Pocket Concierge service operator decreases the price to the end-user of each tier of service. In a third approach to promotional messages delivered to a Pocket Part, the end-user's high credit rating, purchasing authority, or other qualification criteria are validated, and such end-user's Pocket Part would require payment to the end-user's stored value account in the Pocket Part, shipment of a sample, or some other consideration in the end-user's or end-user's employer's or principal's favor, to enable the receipt of an advertisement, coupon, or other promotional message in the end-user's Pocket Part; receipt of such a message can also trigger a payment by the merchant to the Pocket Concierge service operator for providing a qualified prospect. Non-electronic coupons, vouchers, or tickets related to the advertisements or purchases could be printed at printing stations provided by the Pocket Concierge operator, at any printer with a infrared or proximate area network interface, or forwarded to the address (hotel, business, or home) of the end-user.

Promotional messages delivered to a Pocket Part can be multimedia. Additional sales information, documentation, etc., especially in the case of technical or costly items, could be sent to the end-user's attention at a Network address for later retrieval by the end-user. The type of promotional message reflects the specific transaction. In a leisure market application, a tourist can be shown video on the Pocket Part of a restaurant interior, entrees, entertainers, etc., to solicit a reservation or walk-in visit. In a business market application, a purchasing manager can be shown the product, installation methods, testimonials by respected experts, customizations, etc.

Payment for purchases made by an end-user using a Pocket Part can be made electronically and transmitted over the proximate area network, e.g., by debiting a stored value account in the Pocket Part (the electronic equivalent of a cash sale), or by debit card, credit card, or charge card. Such electronic payments would normally be encrypted or made secure by other techniques known in the art. Alternatively, the end-user could make a physical payment, but would be rewarded for reporting to the Pocket Concierge service operator physical payments (e.g., the reward could be offsets against surcharges), which would enable the service operator to collect a sales commission from the merchant based on a sales receipt number or equivalent.

Sales of goods and services marketed by the Pocket Concierge operator (direct sales) would generate direct sales revenue for the Pocket Concierge operator. Sales of goods and services by a third party advertiser would generate commission revenue for the Pocket Concierge operator. When a purchase is made interactively in response to a third party's advertisement on the Pocket Part, or by use of a coupon, the Pocket Concierge service operator earns a commission on the sale as negotiated by the Pocket Concierge service operator and the advertiser or merchant. The use of the Pocket Concierge service could be free to an end-user if a threshold amount of purchases are made; as discussed above, purchases could also generate credits that offset usage surcharges.

Transaction histories and follow-on marketing. Subject to information privacy laws or to contracts between the Pocket Concierge service operator and end-users, the history of transactions entered into by the end-user can be used for later marketing campaigns directed to end-users, for instance, to offer replenishment of consumables, upgrades, or replacements of items purchased by the end-user. For negotiations that did not lead to sales, merchants could send follow-up offers. For anonymous sales and for negotiations that did not lead to sales, the identity of the end-user can be shielded from the merchant by a screening service provided by the Pocket Concierge service operator. Whether the transaction history information is used for follow-on marketing purposes or not, the operator of the Pocket Concierge service normally retains that end-user's account information online. In the event such end-user again subscribes to Pocket Concierge service, the transaction history and preferences can be updated and used to extend suggestions and promotional messages to the end-user.

Service tiers and fee-based upgrades. For leisure market segments, such as the travel industry, specified combinations and amounts (by time or packet) of: Call Center usage, Internet access, entertainment (e.g., live television and radio from the end-user's country or from other countries using an MPEG 4 or equivalent bitcasting feed or other digital compression technology), prerecorded programming, single player or multiplayer games, local, interstate and international voice calling, video calling between Pocket Parts, specialized database or application server access, and other information services are aggregated into various “tiers” of Pocket Concierge service.

For company employees in business market segments, Pocket Concierge service tiers normally reflect job responsibilities and network privileges. A company can operate its own Pocket Concierge service as an extension of an existing helpdesk, can outsource the management of Pocket Parts and wireless services to an outsourcing provider to supplement an existing helpdesk, or can outsource the entire Pocket Concierge service operation. The Pocket Concierge service can be very effective in strengthening and expanding supply chains and distribution channels. In supply chain and project team usage, key personnel at suppliers to, or joint venturers with, a company access the company's intranet and internal phone system using the Pocket Concierge service using directories loaded in the Pocket Part or accessible over the Network by the Pocket Part. In distribution channel management, sales representatives (e.g., detail persons for a pharmaceutical manufacturer) use the Pocket Concierge service to answer prospect and customer questions while meeting with such prospects and customers, or during Q&A sessions at larger meetings. During such meetings, the optional audio and video external output from the Pocket Part can be fed to a sound systems, monitor, or videoprojector for group viewing.

Additional amounts of information services can be purchased as an upgrade package or on an a la carte basis to supplement the service amounts provided in the various tiers of Pocket Concierge service. Such additional services could include access to fee-based database and application servers operated by third parties, e.g., econometrics, investment analytics, just-in-time training, etc.; such sales would generate commission revenue for the Pocket Concierge service operator. Constant improvements in information technology have accelerated the adoption of lifelong learning. Justin-time training delivered over a Pocket Part provides a new, cost-effective method to deliver such training, especially when the subject matter involves locations where traditional multimedia computers or interactive audiovisual devices are inconvenient, such as mobile work, outdoor work, or education and training in areas with poor wireline communications infrastructure.

Peripheral rental; ad hoc videoconferencing. Pocket Parts can be equipped with interfaces to support external displays, external digital cameras, printers, amplifiers and loudspeakers, microphones, external sensors, and other types of peripherals and instrumentation. The Pocket Concierge service operator can rent such peripherals to end-users. In particular, as Pocket Concierge services became available in more cities, a Pocket Part, videoprojector, sound system, and external camera could provide a cost effective method of ad hoc videoconferencing. Telemedicine offers many opportunities for ad hoc videoconferencing and telemetry, especially for emergency medicine and disaster relief. A Pocket Part can be used to permit medical staff at or networked with a Call Center to participate in delivering medical services at the scene of an accident or natural disaster. A Pocket Part used with air or water navigation services can assist aviators and sailors in distress. Emergency medicine use of a Pocket Part normally involves data transmission of vital signs of injured persons and high datarate videoconferencing (since accurate color information and high resolution are important in medical diagnoses). Consequently, Pocket Parts designed for use by emergency medical teams, law enforcement officers, and fire engine crews normally include better quality video and audio components.

Maintenance. Wide distribution, especially on an international scale, of traditional computers normally creates major maintenance problems and expenses. Troubleshooting problems with high technology equipment often requires skills that may not be available in foreign countries. Pocket Parts are small enough to send by air express services back to central maintenance depots for maintenance and hardware upgrades. Software upgrades of Pocket Parts are normally handled by flash upgrades of firmware, even while Pocket Parts are in the field. Moreover, the small size of the Pocket Parts makes maintaining a large inventory of devices very easy. If a Pocket Part unit fails, a replacement unit is delivered to the end-user or swapped at a service counter.

I claim:

1. A method of providing information services, comprising:
using a Call Center to provide multimedia applications selected from the group comprising navigational, informational, commercial, and communications services to at least one Pocket Part by means of a wireless digital network selected from the group comprising a mobile telephone network and a proximate area network;
wherein the primary user interface on the Pocket Part is selected from the group comprising touch-sensitive display panel, voice recognition, soft keyboard, conversation with a person associated with the Call Center, and conversation with a software agent associated with the Call Center.

2. The method of claim 1, further comprising the provision of navigational services by:
equipping a Pocket Part with a video camera with sensitivity and processing in a spectral range selected from the group comprising visible light, infrared, and multispectral;
matching at the Call Center or a Network server the video output from the Pocket Part camera showing the locale of an end-user of the Pocket Part with a wireframe model of that locale sourced from a Call Center or Network server;
superimposing the wireframe model on the video of the locale sourced from the end-user's Pocket Part;
sourcing from the Call Center or Network server additional textual detail about features in the locale, and additional iconic and textual detail about navigating to points within the locale shown in the video sourced from the end-user's Pocket Part;
superimposing the additional detail on the locale video with reference to features in the wireframe model to create a composite video;
transmitting a composite video of locale video, wireframe model, and additional detail to the end-user's Pocket Part, and
displaying the composite video on the display of the Pocket Part.

3. A method of providing information services, comprising:
exchanging between a Pocket Part and a Call Center requests by a user of the Pocket Part and responses to those requests;
wherein the primary user interface on the Pocket Part is selected from the group comprising touch-sensitive display panel, voice recognition, soft keyboard, conversation with a person associated with the Call Center, and conversation with a software agent associated with the Call Center;
wherein the messages exchanged between the Pocket Part and the Call Center are in digital format and are via wireless transmission; and
wherein an audio, user interface between the Pocket Part and the user of the Pocket Part is selected from the group comprising a wireless headset, wireless earset (an ear-mounted headphone and microphone with wireless transmit and receive connectivity to the Pocket Part), wired headset, and wired earset.

4. A method of providing information services, comprising:
using a Pocket Part enrolled in an inventory tracking program resident on a Pocket Part asset management server interfaced with a serving Call Center;
exchanging between the Pocket Part and the asset management server messages concerning asset management;
exchanging between the Pocket Part and the Call Center requests by a user of the Pocket Part and responses to those requests;
wherein the primary user interface on the Pocket Part is selected from the group comprising touch-sensitive display panel, voice recognition, soft keyboard, conversation with a person associated with the Call Center, and conversation with a software agent associated with the Call Center;
wherein the messages exchanged between the Pocket Part and the Call Center are in digital format and are via wireless transmission; and
wherein an audio, user interface between the Pocket Part and the user of the Pocket Part is selected from the group comprising a wireless headset, wireless earset (an ear-mounted headphone and microphone with wireless transmit and receive connectivity to the Pocket Part), wired headset, and wired earset.

5. The method of claim 3 or 4, further comprising:
using wireline transmission as a backup transmission path between the Pocket Part and the Call Center when the Pocket Part is in a location where wireless service unavailable or unreliable.

6. The method of claim 3 or 4, further comprising:
equipping the Pocket Part with a user interface selected from the group comprising eye goggle, tactile/skin pad, and video recognition.

7. The method of claim 3 or 4, further comprising:
equipping the Pocket Part with a proximate area network interface; and
using a proximate area network for local wireless communications between the Pocket Part and proximate area network nodes selected from the group comprising Point of Sale, Point of Offer, navigational, and inventory tracking.

8. The method of claim 3 or 4, further comprising:
using a Network interfaced with the Call Center and with one ore more servers to provide services requested by a user of the Pocket Part.

9. The method of claim 3 or 4, further comprising:
equipping the Pocket Part with a sensor selected from the group comprising medical sensors, environmental sensors, panic button, dosimeters, audio transducers, video transducers, and impact transducers;
providing sensor output signals to a server interfaced with the Call Center; and
dispatching assistance to a user of the Pocket Part based on analysis of the sensor output.

10. The method of claim 3 or 4, further comprising:
equipping the Call Center with a means of natural language translation; and
providing natural language translation of the messages exchanged between a user of the Pocket Part and a person selected from the group comprising a Call Center operator and a third party in communication with the Call Center over a Network.

11. The method of claim 3 or 4, further comprising:
equipping the Pocket Part and the Call Center with a means for determining the geographic location of the Pocket Part and for exchanging geographic location messages between the Pocket Part and the Call Center; and
presenting navigational instructions to a user of the Pocket Part based on the geographic location messages and on input by the user of the Pocket Part.

12. The method of claim 3 or 4, further comprising:
periodically polling the location of each Pocket Part managed by an asset management server interfaced with the Call Center to determine compliance with predefined geographic limits of permitted use of the Pocket Part; and
if a given Pocket Part is located outside the predefined geographic limits of permitted use of the Pocket Part, implementing a predefined response selected from the group comprising a warning that user functionality will be disabled unless the Pocket Part is returned to within permitted geographic limits, a warning that surcharges will be incurred while the Pocket Part is outside permitted geographic limits, disablement of user functionality of the Pocket Part, and surcharging the user for having the Pocket Part outside predefined geographic limits.

13. The method of claim 3 or 4, further comprising:
determining the geographic location of the Pocket Part using a method selected from the group comprising RF triangulation, RF proximity detection via a proximate area network, announcements by the Pocket Part over a Network, and transaction history.

14. The method of claim 3 or 4, further comprising:
equipping the Pocket Part with a button or menu selection that, when activated, causes an instant display on the Pocket Part of the location of the user and of other points of interest of types selected by the user in a given locale.

15. The method of claim 3 or 4, further comprising:
enabling user functionality of the Pocket Part only so long as the Pocket Part receives a “keep alive” command from an asset management server interfaced with the Call Center.

16. The method of claim 3 or 4, further comprising:
equipping the Pocket Part with an RF tag;
detecting RF tags in proximity to an RF tag detector, and
using messages between RF tag detectors and an inventory tracking program resident on an asset management server interfaced to the Call Center to track the location of the Pocket Part.

17. The method of claim 3 or 4, further comprising:
equipping the Pocket Part and a server interfaced with the Call Center with application software tailored to industry sectors selected from the group comprising financial services, pharmaceuticals, sales force automation, security, engineering, construction, medical, manufacturing, extractive, legal, supply chain, distribution channel, retail sales, and travel industry;
transmitting to the Pocket Part from the server in response to Pocket Part user or Call Center operator inquiry information responsive to such inquiry, wherein such responsive information is selected from the group comprising multimedia and single medium (audio, video, text, or graphics); and
displaying such information on the Pocket Part.

18. The method of claim 3 or 4, further comprising:
loading servers interfaced with the Call Center with information selected from the group comprising product information, destination information, service information, training, and educational information;
providing resources selected from the group comprising persons, databases, and software agents, each with connectivity to the Call Center; and
distributing to a Pocket Part information requested by a user of the Pocket Part and obtained from such resources; and
presenting such information on the Pocket Part, wherein such presentation is selected from the group comprising multimedia and single medium (audio, video, text, or graphics).

19. The method of claim 3 or 4, further comprising:
equipping the Call Center with a means for directory number translation (“follow me service”) so that voice, fax, video, and data calls intended for other network addresses (including telephone numbers) of a user of a Pocket Part are delivered to such user on the Pocket Part.

20. The method of claim 3 or 4, further comprising:
equipping servers interfaced with the Call Center with a means for storing and forwarding messages and a means for message payload conversion;
converting message payloads between formats selected from the group comprising voice and text; and
forwarding messages in a format specified by a user of a Pocket Part to that user's Pocket Part.

21. The method of claim 3 or 4, further comprising:
equipping servers interfaced with the Call Center with a means for storing and forwarding messages and a means for message payload conversion;
converting message payloads between formats selected from the group comprising fax, graphics, and video; and
forwarding messages in a format specified by a user of a Pocket Part to that user's Pocket Part.

22. The method of claim 3 or 4, further comprising:
interfacing with the Call Center one or more servers containing foreign language information;
equipping the Pocket Part and one or more Call Center servers with foreign language application software;
staffing the seats in the Call Center with personnel competent in the foreign language and in one or more languages of the locale in which the Pocket Part is used;
providing to the Pocket Part in a foreign language selected by the user of the Pocket Part oral and server-based information related to the locale; and
optionally, providing to the Pocket Part in a local language oral and server-based information related to such locale.

23. The method of claim 3 or 4, further comprising:
reducing transmission capacity required between the Call Center and the Pocket Part by storing in the Pocket Part software components selected from the group comprising graphic elements, lip motion rules, and body motion rules; and
using such components in generating content presented on the Pocket Part.

24. The method of claim 3 or 4, further comprising:
responding to inquiries from a user of the Pocket Part concerning the location of goods or services by transmitting to the Pocket Part location and navigational information selected from the group comprising text, video, audio, and graphics and oriented to the user's present position.

25. The method of claim 3 or 4, further comprising:
providing to a user of the Pocket Part services selected from the group comprising assistance from personnel associated with a Call Center, assistance from software agents, access to one or more databases, access to one or more application servers, Internet access, live television programming, live radio programming, news, weather forecasts, prerecorded audio programming, prerecorded video programming, single player games, multiplayer games, data calling, local calling, domestic long distance calling, international long distance calling, video calling, location reporting, navigational guidance, private network access, contests, fax, email, paging, web browsing, messaging, conferencing, telemedicine, telesecurity, remote sensing using sensors associated with the Pocket Part, access to sensors interfaced with the Call Center, remote diagnostics, reservations, entertainment, shopping/procurement, industry sector (financial services, pharmaceuticals, sales force automation, security, engineering, construction, medical, manufacturing, extractive, legal, supply chain management, distribution channel management, and travel industry) software applications, industry sector information services, fee-based services, educational courseware, and training courseware.

26. The method of claim 3 or 4, further comprising:
providing to a user of the Pocket Part services packaged and quantified (by call-minutes or packets) in tiers, wherein such communications and information services are selected from the group comprising assistance from personnel associated with a Call Center, assistance from software agents, access to one or more databases, access to one or more application servers, Internet access, live television programming, live radio programming, news, weather forecasts, prerecorded audio programming, prerecorded video programming, single player games, multiplayer games, data calling, local calling, domestic long distance calling, international long distance calling, video calling, location reporting, navigational guidance, private network access, contests, fax, email, paging, web browsing, messaging, conferencing, telemedicine, telesecurity, remote sensing using sensors associated with the Pocket Part, access to sensors interfaced with the Call Center, remote diagnostics, reservations, entertainment, shopping/procurement, industry sector (financial services, pharmaceuticals, sales force automation, security, engineering, construction, medical, manufacturing, extractive, legal, supply chain management, distribution channel management, and travel industry) software applications, industry sector information services, fee-based services, educational courseware, and training courseware.

27. The method of claim 3 or 4, further comprising:
providing to a user of the Pocket Part services packaged and quantified (by call-minutes or packets) in tiers, wherein such services are selected from the group comprising assistance from personnel associated with a Call Center, assistance from software agents, access to one or more databases, access to one or more application servers, Internet access, live television programming, live radio programming, news, weather forecasts, prerecorded audio programming, prerecorded video programming, single player games, multiplayer games, data calling, local calling, domestic long distance calling, international long distance calling, video calling, location reporting, physical security, building access, room access, navigational guidance, private network access, contests, fax, email, paging, web browsing, messaging, conferencing, telemedicine, telesecurity, remote sensing using sensors associated with the Pocket Part, access to sensors interfaced with the Call Center, remote diagnostics, reservations, entertainment, shopping/procurement, industry sector (financial services, pharmaceuticals, sales force automation, security, engineering, construction, medical, manufacturing, extractive, legal, supply chain management, distribution channel management, and travel industry) software applications, industry sector information services, fee-based services, educational courseware, and training courseware; and
using software running on an asset management server interfaced with the Call Center to authorize and account for the usage of such services by the Pocket Part, and in response to a user's attempt to use services and amounts not included in a given tier to generate a response selected from the group comprising blocking such attempted use, permitting such attempted use by surcharging the user, or escalating the tier level subscribed to by the user and charging the user for such higher tier.

28. The method of claim 3 or 4, further comprising:
providing to a user of the Pocket Part enrollment in a reward system based on an action by the user selected from the group comprising purchase by the user of goods or services, performance by the user in games, participation by the user in a contest, participation by the user in market research, and the user's viewing advertisements.

29. The method of claim 3 or 4, further comprising:
equipping the Pocket Part with a digital camera; and
transmitting the digital camera output from the Pocket Part to the Call Center for storage or further transmission.

30. The method of claim 3 or 4, further comprising:
equipping the Pocket Part with a digital camera; and
storing the digital camera output in the Pocket Part.

31. The method of claim 3 or 4, further comprising:
transmitting one or more electronic coupons from the Call Center to the Pocket Part to promote purchasing by a user of the Pocket Part;
transmitting the one or more electronic coupon from the Pocket Part to a Point of Sale; and
redeeming the one or more electronic coupons after transmission of an electronic coupon from the Pocket Part to the Point of Sale.

32. The method of claim 3 or 4, further comprising:
collecting revenue by an operator of the Call Center based on the sales to a user of the Pocket Part of items selected from the group comprising communications services, information services, commercial services, goods sold by the operator of the Call Center to the user of the Pocket Part, other services sold by the operator of the Call Center to the user of the Pocket Part, other services sold by the operator of the Call Center to a vendor to promote the vendor's goods and services, and commissions on sales by third parties to a user of the Pocket Part in which payment is settled through the Pocket Part; and
wherein such other services are selected from the group comprising providing to a user navigation guidance to a vendor's Point of Sale or Point of Offer, providing user preferences to a vendor, providing a user's shopping/procurement information to a vendor, providing vendor advertisements to a user, providing vendor coupons to a user, translating between the language of a vendor's information or staff and the language of a user, charging the vendor for payment of consideration in the user's favor for access to the user, and services that the operator of the Call Center sources from third parties and sells as a service of the Call Center operator.

33. The method of claim 3 or 4, further comprising:
transmitting announcement messages from the Pocket Part to at least one proximate area network receiver for a use selected from the group comprising tracking the location of the Pocket Part, providing the purchasing preferences of a user of the Pocket Part to a Point of Sale or Point of Offer, triggering the transmission of electronic coupons from a Point of Sale or Point of Offer to the Pocket Part, and triggering the transmission of advertisements from a Point of Sale or Point of Offer to the Pocket Part.

34. The method of claim 3 or 4, further comprising:
equipping the Pocket Part with software that negotiates with software agents or human representatives of merchants whose Points of Offer or Points of Sale are within proximate area network range;
presenting an offer transmitted from a Point of Offer or Point of Sale to a user of the Pocket Part user in a language specified by the user.

35. The method of claim 3 or 4, further comprising:
equipping the Pocket Part with a payment means to facilitate sales transactions using the Pocket Part and selected from the group comprising credit card swipe reader, stored value memory, and stored value card; and
settling payment for purchases made by a user of the Pocket Part by use of such payment means.

36. The method of claim 3 or 4, further comprising:
transmitting information responsive to an inquiry from a user of the Pocket Part to a network or postal address specified by the user.

37. The method of claim 3 or 4, further comprising:
maintaining a history of purchase negotiations entered into by a user of the Pocket Part; and
using the information in such transactional history in follow-up marketing efforts to the user.

38. The method of claim 3 or 4, further comprising:
enabling a user of a Pocket Part to be anonymous in purchase negotiations by providing a proxy identification for the user to use in payments settled through the Pocket Part, but maintaining a cross-reference to the user's true identity on a server interfaced with the Call Center.

39. The method of claim 3 or 4, further comprising:
maintaining the identification and transactional history of a user of the Pocket Part on a server interfaced with the Call Center, and in the event such user again uses a Pocket Part, updating the transactional history of such user and extending suggestions and promotional messages to the user based on such transactional history.

40. The method of claim 3 or 4, further comprising:
equipping the Pocket Part with one or more interfaces to support external devices selected from the group comprising displays, digital cameras, printers, amplifiers, loudspeakers, microphones, external sensors, sensors, and instrumentation.

41. The method of claim 3 or 4, further comprising:
equipping the Pocket Part with one or more sensors that monitor vital signs of a user of the Pocket Part or of a person in proximity to and with connectivity to the Pocket Part; and
transmitting the output of such sensors to a server interfaced with the Call Center.

42. The method of claim 3 or 4, further comprising:
equipping the Pocket Part with one or more sensors that monitor vital signs of a user of the Pocket Part or of a person in proximity to and with connectivity to the Pocket Part;
equipping the Pocket Part with software that monitors the one or more sensors and determines if a predefined vital sign threshold is exceeded; and
if such threshold is exceeded, transmitting to a server interfaced with the Call Center a message selected from the group comprising the vital sign exceeding such threshold, specified sensor outputs, all sensor outputs, and the location of the Pocket Part.

43. A system of providing information services, comprising:
a means for exchanging between a Pocket Part and a Call Center requests by a user of the Pocket Part and responses to those requests;
wherein the primary user interface on the Pocket Part is selected from the group comprising touch-sensitive display panel, voice recognition, soft keyboard, conversation with a person associated with the Call Center, and conversation with a software agent associated with the Call Center;
wherein the messages exchanged between the Pocket Part and the Call Center are in digital format and are via wireless transmission; and
wherein an audio, user interface between the Pocket Part and the user of the Pocket Part is selected from the group comprising a wireless headset, wireless earset (an ear-mounted headphone and microphone with wireless transmit and receive connectivity to the Pocket Part), wired headset, and wired earset.

44. A system of providing information services, comprising:
a means for enrolling a Pocket Part in an inventory tracking program resident on a Pocket Part asset management server interfaced with a serving Call Center;
a means for exchanging between the Pocket Part and the asset management server messages concerning asset management;
a means for exchanging between the Pocket Part and the Call Center requests by a user of the Pocket Part and responses to those requests;
wherein the primary user interface on the Pocket Part is selected from the group comprising touch-sensitive display panel, voice recognition, soft keyboard, conversation with a person associated with the Call Center, and conversation with a software agent associated with the Call Center;
wherein the messages exchanged between the Pocket Part and the Call Center are in digital format and are via wireless transmission; and
wherein an audio, user interface between the Pocket Part and the user of the Pocket Part is selected from the group comprising a wireless headset, wireless earset (an ear-mounted headphone and microphone with wireless transmit and receive connectivity to the Pocket Part), wired headset, and wired earset.

45. The system of claim 43 or 44, further comprising:
a wireline transmission path as a backup transmission path between the Pocket Part and the Call Center when the Pocket Part is in a location where wireless service unavailable or unreliable.

46. The system of claim 43 or 44, further comprising:
a Pocket Part user interface selected from the group comprising eye goggle, tactile/skin pad, and video recognition.

47. The system of claim 43 or 44, further comprising:
a proximate area network interface on the Pocket Part; and
a proximate area network for local wireless communications between the Pocket Part and proximate area network nodes selected from the group comprising Point of Sale, Point of Offer, navigational, and inventory tracking.

48. The system of claim 43 or 44, further comprising:
a Network interfaced with the Call Center and with one ore more servers to provide services requested by a user of the Pocket Part.

49. The system of claim 43 or 44, further comprising:
a sensor interfaced with the Pocket Part and selected from the group comprising medical sensors, environmental sensors, panic button, dosimeters, audio transducers, video transducers, and impact transducers;
a means for transmitting sensor output signals to a server interfaced with the Call Center; and
a means for dispatching assistance to a user of the Pocket Part based on analysis of the sensor output.

50. The system of claim 43 or 44, further comprising:
a means for translating natural languages at the Call Center; and
natural language translation of the messages exchanged between a user of the Pocket Part and a person selected from the group comprising a Call Center operator and a third party in communication with the Call Center over a Network.

51. The system of claim 43 or 44, further comprising:
a means on the Pocket Part and a means interfaced with the Call Center for determining the geographic location of the Pocket Part and for exchanging geographic location messages between the Pocket Part and the Call Center; and
a means on the Pocket Part for presenting navigational instructions provided from the Call Center to a user of the Pocket Part based on the geographic location messages and on input by the user of the Pocket Part.

52. The system of claim 43 or 44, further comprising:
a means for periodically polling the location of each Pocket Part managed by an asset management server interfaced with the Call Center to determine compliance with predefined geographic limits of permitted use of the Pocket Part; and
a means for implementing a predefined response selected from the group comprising a warning that user functionality will be disabled unless the Pocket Part is returned to within permitted geographic limits, a warning that surcharges will be incurred while the Pocket Part is outside permitted geographic limits, disablement of user functionality of the Pocket Part, and surcharging the user for having the Pocket Part outside predefined geographic limits.

53. The system of claim 43 or 44, further comprising:
a means for determining the geographic location of the Pocket Part using a method selected from the group comprising RF triangulation, RF proximity detection via a proximate area network, announcements by the Pocket Part over a Network, and transaction history.

54. The system of claim 43 or 44, further comprising:
a button or menu selection on the Pocket Part that, when activated, causes an instant display on the Pocket Part of the location of the user and of other points of interest of types selected by the user in a given locale.

55. The system of claim 43 or 44, further comprising:
a means for enabling user functionality of the Pocket Part only so long as the Pocket Part receives a “keep alive” command from an asset management server interfaced with the Call Center.

56. The system of claim 43 or 44, further comprising:
an RF tag integral with the Pocket Part;
detection of such RF tags in proximity to RF tag detectors, and
messages between RF tag detectors and an inventory tracking program resident on an asset management server interfaced to the Call Center to track the location of the Pocket Part.

57. The system of claim 43 or 44, further comprising:
application software running on the Pocket Part and a server interfaced with the Call Center and tailored to industry sectors selected from the group comprising financial services, pharmaceuticals, sales force automation, security, engineering, construction, medical, manufacturing, extractive, legal, supply chain, distribution channel, retail sales, and travel industry; and
a means for transmitting to the Pocket Part from the server in response to Pocket Part user or Call Center operator inquiry information responsive to such inquiry, wherein such responsive information is selected from the group comprising multimedia and single medium (audio, video, text, or graphics);
wherein such responsive information is presented by the Pocket Part.

58. The system of claim 43 or 44, further comprising:
servers interfaced with the Call Center and loaded with information selected from the group comprising product information, destination information, service information, training, and educational information;
resources selected from the group comprising persons, databases, and software agents, each with connectivity to the Call Center;
a means for distributing to a Pocket Part of information requested by a user of the Pocket Part and obtained from such resources; and
a means for presenting such information on the Pocket Part, wherein such presentation is selected from the group comprising multimedia and single medium (audio, video, text, or graphics).

59. The system of claim 43 or 44, further comprising:
a means associated with the Call Center for directory number translation (“follow me service”) so that voice, fax, video, and data calls intended for other network addresses (including telephone numbers) of a user of a Pocket Part are delivered to such user on the Pocket Part.

60. The system of claim 43 or 44, further comprising:
servers interfaced with the Call Center and equipped with a means for storing and forwarding messages and a means for message payload conversion;
a means for conversion of message payloads between formats selected from the group comprising voice and text; and
a means for forwarding messages in a format specified by a user of a Pocket Part to that user's Pocket Part.

61. The system of claim 43 or 44, further comprising:
servers interfaced with the Call Center and equipped with a means for storing and forwarding messages and a means for message payload conversion;
a means for conversion of message payloads between formats selected from the group comprising fax, graphics, and video; and
a means for forwarding messages in a format specified by a user of a Pocket Part to that user's Pocket Part.

62. The system of claim 43 or 44, further comprising:
one or more servers interfaced with the Call Center and containing foreign language information;
foreign language application software running on the Pocket Part and on one or more servers in the Call Center;
personnel competent in one or more languages of the locale in which the Pocket Part is used, which personnel staff seats in the Call Center;
a means for providing to the Pocket Part in a foreign language selected by the user oral and server-based information related to the locale; and
optionally, a means for providing to the Pocket Part in a local language oral and server-based information related to such locale.

63. The system of claim 43 or 44, further comprising:
software components in the Pocket Part selected from the group comprising graphic elements, lip motion rules, and body motion rules that reduce transmission capacity required between the Call Center and the Pocket Part; and
a means for using such components in generating content presented on the Pocket Part.

64. The system of claim 43 or 44, further comprising:
a means for responding to inquiries from a user of the Pocket Part concerning the location of goods or services by transmitting to the Pocket Part location and navigational information selected from the group comprising text, video, audio, and graphics and oriented to the user's present position.

65. The system of claim 43 or 44, further comprising:
services provided to a user of the Pocket Part and selected from the group comprising assistance from personnel associated with a Call Center, assistance from software agents, access to one or more databases, access to one or more application servers, Internet access, live television programming, live radio programming, news, weather forecasts, prerecorded audio programming, prerecorded video programming, single player games, multiplayer games, data calling, local calling, domestic long distance calling, international long distance calling, video calling, location reporting, navigational guidance, private network access, contests, fax, email, paging, web browsing, messaging, conferencing, telemedicine, telesecurity, remote sensing using sensors associated with the Pocket Part, access to sensors interfaced with the Call Center, remote diagnostics, reservations, entertainment, shopping/procurement, industry sector (financial services, pharmaceuticals, sales force automation, security, engineering, construction, medical, manufacturing, extractive, legal, supply chain management, distribution channel management, and travel industry) software applications, industry sector information services, fee-based services, educational courseware, and training courseware.

66. The system of claim 43 or 44, further comprising:
services provided to a user of the Pocket Part and packaged and quantified (by call-minutes or packets) in tiers, wherein such services are selected from the group comprising assistance from personnel associated with a Call Center, assistance from software agents, access to one or more databases, access to one or more application servers, Internet access, live television programming, live radio programming, news, weather forecasts, prerecorded audio programming, prerecorded video programming, single player games, multiplayer games, data calling, local calling, domestic long distance calling, international long distance calling, video calling, location reporting, navigational guidance, private network access, contests, fax, email, paging, web browsing, messaging, conferencing, telemedicine, telesecurity, remote sensing using sensors associated with the Pocket Part, access to sensors interfaced with the Call Center, remote diagnostics, reservations, entertainment, shopping/procurement, industry sector (financial services, pharmaceuticals, sales force automation, security, engineering, construction, medical, manufacturing, extractive, legal, supply chain management, distribution channel management, and travel industry) software applications, industry sector information services, fee-based services, educational courseware, and training courseware.

67. The system of claim 43 or 44, further comprising:
services provided to a user of the Pocket Part and packaged and quantified (by call-minutes or packets) in tiers, wherein such services are selected from the group comprising assistance from personnel associated with a Call Center, assistance from software agents, access to one or more databases, access to one or more application servers, Internet access, live television programming, live radio programming, news, weather forecasts, prerecorded audio programming, prerecorded video programming, single player games, multiplayer games, data calling, local calling, domestic long distance calling, international long distance calling, video calling, location reporting, physical security, building access, room access, navigational guidance, private network access, contests, fax, email, paging, web browsing, messaging, conferencing, telemedicine, telesecurity, remote sensing using sensors associated with the Pocket Part, access to sensors interfaced with the Call Center, remote diagnostics, reservations, entertainment, shopping/procurement, industry sector (financial services, pharmaceuticals, sales force automation, security, engineering, construction, medical, manufacturing, extractive, legal, supply chain management, distribution channel management, and travel industry) software applications, industry sector information services, fee-based services, educational courseware, and training courseware; and
software running on an asset management server interfaced with the Call Center that authorizes and accounts for the usage of such services by the Pocket Part, and in response to a user's attempt to use services and amounts not included in a given tier, generates a response selected from the group comprising blocking such attempted use, permitting such attempted use by surcharging the user, or escalating the tier level subscribed to by the user and charging the user for such higher tier.

68. The system of claim 43 or 44, further comprising:
a reward system based on an action by the user selected from the group comprising purchase by the user of the Pocket Part of goods or services, performance by the user of the Pocket Part in games, participation by the user of the Pocket Part in a contest, participation by the user of the Pocket Part in market research, and the user's viewing advertisements.

69. The system of claim 43 or 44, further comprising:
a digital camera interfaced with the Pocket Part; and
a means for transmitting the digital camera output from the Pocket Part to the Call Center for storage or further transmission.

70. The system of claim 43 or 44, further comprising:
a digital camera interfaced with the Pocket Part; and
a means for storing the digital camera output in the Pocket Part.

71. The system of claim 43 or 44, further comprising:
one or more electronic coupons transmitted from the Call Center to the Pocket Part to promote purchasing by a user of the Pocket Part;
a means for transmitting such coupons from the Pocket Part to a Point of Sale; and
a means for redeeming the one or more electronic coupons after transmission of a such coupons from the Pocket Part to the Point of Sale.

72. The system of claim 43 or 44, further comprising:
a means for collecting revenue by an operator of the Call Center based on the sales to a user of the Pocket Part of items selected from the group comprising communications services, information services, commercial services, goods sold by the operator of the Call Center to the user of the Pocket Part, other services sold by the operator of the Call Center to the user of the Pocket Part, other services sold by the operator of the Call Center to a vendor to promote the vendor's goods and services, and commissions on sales by third parties to a user of the Pocket Part in which payment is settled through the Pocket Part; and
wherein such other services are selected from the group comprising providing to a user navigation guidance to a vendor's Point of Sale or Point of Offer, providing user preferences to a vendor, providing a user's shopping /procurement information to a vendor, providing vendor advertisements to a user, providing vendor coupons to a user, translating between the language of a vendor's information or staff and the language of a user, charging the vendor for payment of consideration in the user's favor for access to the user, and services that the operator of the Call Center sources from third parties and sells as a service of the Call Center operator.

73. The system of claim 43 or 44, further comprising:
announcement messages transmitted from the Pocket Part to at least one proximate area network receiver for a use selected from the group comprising tracking the location of the Pocket Part, providing the purchasing preferences of a user of the Pocket Part to a Point of Sale or Point of Offer, triggering the transmission of electronic coupons from a Point of Sale or Point of Offer to the Pocket Part, and triggering the transmission of advertisements from a Point of Sale or Point of Offer to the Pocket Part.

74. The system of claim 43 or 44, further comprising:
software running on the Pocket Part that negotiates with software agents or human representatives of merchants whose Points of Offer or Points of Sale are within proximate area network range;
one or more offers transmitted from a Point of Offer or Point of Sale to a user of the Pocket Part user in a language specified by the user.

75. The system of claim 43 or 44, further comprising:
a means for facilitating sales transactions interfaced with the Pocket Part and selected from the group comprising credit card swipe reader, stored value memory, and stored value card; and
a means for settlement of payment for purchases made by a user of the Pocket Part by use of such facilitating means.

76. The system of claim 43 or 44, further comprising:
a means for transmitting information responsive to an inquiry from a user of the Pocket Part to a network or postal address specified by the user.

77. The system of claim 43 or 44, further comprising:
a means for maintaining a history of purchase negotiations entered into by a user of the Pocket Part; and
a means for using the information in such transactional history in follow-up marketing efforts to the user.

78. The system of claim 43 or 44, further comprising:
a means for enabling a user of a Pocket Part to be anonymous in purchase negotiations by providing a proxy identification for the user to use in payments settled through the Pocket Part, but maintaining a cross-reference to the user's true identity on a server interfaced with the Call Center.

79. The system of claim 43 or 44, further comprising:
a means for maintaining the identification and transactional history of a user of the Pocket Part on a server interfaced with the Call Center, and in the event such user again uses a Pocket Part, updating the transactional history of such user and extending suggestions and promotional messages to the user based on such transactional history.

80. The system of claim 43 or 44, further comprising:
one or more interfaces integral with the Pocket Part that support external devices selected from the group comprising displays, digital cameras, printers, amplifiers, loudspeakers, microphones, external sensors, sensors, and instrumentation.

81. The system of claim 43 or 44, further comprising:
one or more sensors interfaced with the Pocket Part that monitor vital signs of a user of the Pocket Part or of a person in proximity to and with connectivity to the Pocket Part; and
transmission of the output of such sensors to a server interfaced with the Call Center.

82. The system of claim 43 or 44, further comprising:
one or more sensors interfaced with the Pocket Part that monitor vital signs of a user of the Pocket Part or of a person in proximity to and with connectivity to the Pocket Part;
software running of the Pocket Part that monitors the one or more sensors and determines if a predefined vital sign threshold is exceeded; and
if such threshold is exceeded, a means for transmitting from the Pocket Part to a server interfaced with the Call Center a message selected from the group comprising the vital sign exceeding such threshold, specified sensor outputs, all sensor outputs, and the location of the Pocket Part.

83. A method of providing information services, comprising:
a Call Center that provides multimedia applications selected from the group comprising navigational, informational, commercial, and communications services to at least one Pocket Part by means of a wireless digital network selected from the group comprising a mobile telephone network and a proximate area network;
wherein the primary user interface on the Pocket Part is selected from the group comprising touch-sensitive display panel, voice recognition, soft keyboard, conversation with a person associated with the Call Center, and conversation with a software agent associated with the Call Center.

84. The method of claim 83, further comprising the provision of navigational services by:
a Pocket Part equipped with a video camera with sensitivity and processing in a spectral range selected from the group comprising visible light, infrared, and multispectral;
a Call Center or a Network server that matches the video output from the Pocket Part camera showing the locale of an end-user of the Pocket Part with a wireframe model of that locale sourced from a Call Center or Network server, and superimposes the wireframe model on the video of the locale sourced from the end-user's Pocket Part;
Call Center or Network server that provides additional textual detail about features in the locale, and additional iconic and textual detail about navigating to points within the locale shown in the video sourced from the end-user's Pocket Part, and superimposes the additional detail on the locale video with reference to features in the wireframe model to create a composite video; and
transmission of a composite video of locale video, wireframe model, and additional detail to the end-user's Pocket Part, wherein the Pocket Part displays the composite video on the display of the Pocket Part.
